(19) United States
(12) Patent Application Publication
(10) Pub. No.: US 2013/0327292 A1
(43) Pub. Date: Dec. 12, 2013

(54) METHOD FOR OPERATING AN INTERNAL COMBUSTION ENGINE

(71) Applicant: Dr. Ing. h.c. F. Porsche Aktiengesellschaft, Stuttgart (DE)

(72) Inventor: Ernst Friedrich Ostertag, Bad Liebenzell (DE)

(21) Appl. No.: 13/913,899

(22) Filed: Jun. 10, 2013

(30) Foreign Application Priority Data
Jun. 11, 2012 (DE) 102012104994.7

(51) Int. Cl. F02D 17/02

(52) U.S. Cl. CPC F02D 17/02
USPC 123/395

(57) ABSTRACT

A method for operating an internal combustion engine, which includes one or more cylinders, of which individual cylinders can be deactivated and, in an optimized manner with regard to time, reactivated again in order to influence a torque output by the internal combustion engine. To further optimize, with regard to time, the provision of torque during the operation of an internal combustion engine, a time delay and/or a delay in degrees crank angle or revolutions of the internal combustion engine between a triggering and the reactivation of a deactivated cylinder is taken into consideration for the reactivation of the deactivated cylinder.

### CROSS-REFERENCE TO RELATED APPLICATIONS

This application claims priority to German Patent Application No. 10 2012 104 994.7, filed Jun. 11, 2012, which is incorporated by reference herein in its entirety.

### FIELD OF THE INVENTION

The invention relates to a method for operating an internal combustion engine which comprises one or more cylinders, of which individual cylinders can be deactivated and, in an optimized manner with regard to time, reactivated again in order to influence a torque output by the internal combustion engine.

### BACKGROUND OF THE INVENTION

The German laid-open specification DE 102 61 857 A1, which is incorporated by reference in its entirety, discloses a method for operating an internal combustion engine of a motor vehicle, wherein in the event of a load alteration, the engine torque is briefly changed in order to generate a compensation torque for compensating load alteration reactions. Here, a profile with respect to time of an angular acceleration of a flywheel of the internal combustion engine is determined, by differentiation, from a profile with respect to time of an engine speed, and a profile with respect to time of the gradient of the angular acceleration of the flywheel is determined by further differentiation of the profile with respect to time of the angular acceleration, and during a load alteration, a time at which a first sign change of the gradient of the angular acceleration occurs is determined, and the compensation torque is generated at said determined time.

### SUMMARY OF THE INVENTION

Described herein is a method to further optimize, with regard to time, the provision of torque during the operation of an internal combustion engine.

In the case of a method for operating an internal combustion engine which comprises one or more cylinders, of which individual cylinders can be deactivated and, in an optimized manner with regard to time, reactivated again in order to influence a torque output by the internal combustion engine, the method is carried out such that a time delay and/or a delay in degrees crank angle or revolutions of the internal combustion engine between a triggering and the reactivation of a deactivated cylinder is taken into consideration for the reactivation of the deactivated cylinder.

Within the context of the present invention, it has been found that, even in the case of a direct gasoline injection, there is a time delay until a desired torque is realized, specifically even if, through suitable methods, the cylinder in which the next injection is pending is known and the injection in said cylinder is demanded by means of a torque demand.

According to one aspect of the invention, the correct time for the reactivation of the injection of a deactivated cylinder is determined by prediction of the engine speed profile already before a torque demand, such that a time delay that arises even with optimum triggering of the next available cylinder is taken into consideration. In this way, it can be achieved that the required torque is available at exactly the time at which it is required.

A preferred exemplary embodiment of the method is characterized in that a time parameter for the reactivation of a deactivated cylinder is determined already before a corresponding torque demand. This has the advantage that the deactivated cylinder can be triggered in optimum fashion upon the corresponding torque demand.

A further preferred exemplary embodiment of the method is characterized in that a time period encompassed during the deactivation of a cylinder and/or a rotational angle or revolution delay between a triggering and the deactivation of the cylinder is used as a time parameter for the time delay between the triggering and the reactivation of the deactivated cylinder. This approach has proven to be advantageous within the context of the present invention. The time period can be varied according to demand on the basis of empirical values.

A further preferred exemplary embodiment of the method is characterized in that, in an engine speed adaptation process, a torque demand is predicted. According to a further aspect of the invention, a cylinder to be switched off can, in engine speed regulating processes, be determined in pilot-controlled fashion. The time for the reactivation of the injection of the switched-off or deactivated cylinder may then be determined by means of a prediction of the engine speed profile. It is thereby possible for a time delay that arises under certain circumstances to be taken into consideration and avoided.

A further preferred exemplary embodiment of the method is characterized in that a torque demand expected in future is taken as a basis for the injection control and/or reactivation of a deactivated cylinder. The correct time for the reactivation of the injection of the deactivated cylinder is thus determined by prediction of the engine speed profile already before the torque demand.

A further preferred exemplary embodiment of the method is characterized in that the individual cylinders are deactivated/reactivated by deactivation/reactivation of an injection.

### BRIEF DESCRIPTION OF THE DRAWINGS

Further advantages, features and details of the invention will emerge from the following description, in which various exemplary embodiments are described in detail with reference to the drawing, in which:

FIG. 1 shows a highly simplified illustration of the method according to aspects of the invention on the basis of a timeline;

FIG. 2 is an illustration of profiles without prediction, and

FIG. 3 is, for visualization of the method according to aspects of the invention, the same illustration as in FIG. 2 with prediction.

### DETAILED DESCRIPTION OF THE INVENTION

The invention relates to a method for operating an internal combustion engine. The internal combustion engine is an Otto-cycle engine of a motor vehicle. The torque output by the Otto-cycle engine can be influenced not only through air and ignition angle control but also through deactivation of individual combustions. Large torque jumps in particular can often only be achieved in this way. For reasons relating to the exhaust gas, however, a deactivation of the ignition is not admissible; it is necessary to suppress the actual injection for the combustion which is not to be performed.

Since it is the case in a homogeneous operating mode, even in gasoline direct injection combustion processes, that the injection always takes place with an advance of approximately one engine revolution, there is a time delay here until a desired torque is realized, specifically even if, through suitable methods, the cylinder in which the next injection is pending is known and the injection in said cylinder is demanded by means of the torque demand.

For fast regulating processes, such as for example the engine speed adaptation to dual-clutch transmissions, said time delay leads to an unsatisfactory response time even with optimized injection triggering.

According to one essential aspect of the invention, a method is provided for determining the correct time for the reactivation of the injection by prediction of the engine speed profile already before a torque demand, such that a time delay that arises even with optimum triggering of the next available cylinder is taken into consideration. In this way, it can be achieved that the required torque is available at exactly the time at which it is required.

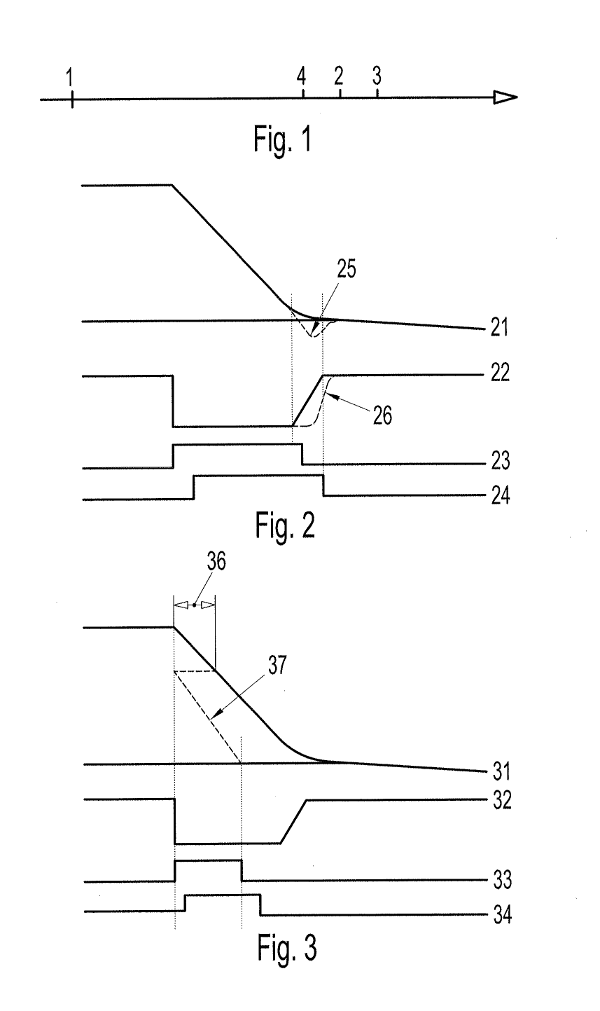

In FIG. 1, a timeline is indicated by an arrow, on which timeline are plotted four times 1 to 4. At time 1, an individual combustion is deactivated. The individual combustion is to be reactivated at the time 2. In the case of normal triggering of the reactivation of the individual combustion at the time 2, the actual reactivation of the combustion first takes place at time 3.

The time delay between the times 2 and 3 is undesirable. According to one essential aspect of the invention, the reactivation of the combustion is triggered already at the time 4. In this way, it is achieved, in a particularly advantageous manner that the actual reactivation of the combustion takes place exactly at time 2.

FIG. 2 illustrates four profile lines 21 to 24 without prediction or forecasting of a torque demand expected in future.

The profile line 21 shows the desired profile of the setpoint engine speed. The profile line 22 shows the profile of the desired setpoint torque. The profile line 23 shows the profile in the case of a demand for a switch-off of a cylinder. The profile line 24 shows the profile of the realization of the switch-off of the cylinder.

A dashed line 25 indicates how the engine speed profile realized differs from the desired engine speed profile. A dashed line 26 indicates how the realized torque profile deviates from the desired setpoint torque profile.

FIG. 3 shows four profile lines 31, 32, 33, 34 with prediction or forecasting of a torque demand predicted in future.

The profile line 31 shows the desired setpoint engine speed profile. The profile line 32 shows the desired setpoint torque profile. The profile line 33 shows the profile of a demand for the switch-off of a cylinder. The profile line 34 shows the profile of the realization of the switch-off of the cylinder.

A double arrow 36 indicates a time delay which, according to the method according to aspects of the invention, is taken into consideration in the reactivation of the deactivated or switched-off cylinder. A dashed line 37 indicates the predicted or forecast engine speed after delay.

What is claimed:

1. A method for operating an internal combustion engine which comprises one or more cylinders, of which individual cylinders are configured to be deactivated and, in an optimized manner with regard to time, reactivated again in order to influence a torque output by the internal combustion engine, wherein a time delay and/or a delay in degrees crank angle or revolutions of the internal combustion engine between a triggering and the reactivation of a deactivated cylinder is taken into consideration for the reactivation of the deactivated cylinder.

2. The method as claimed in claim 1, wherein a time parameter for the reactivation of a deactivated cylinder is determined before a corresponding torque demand.

3. The method as claimed in claim 1, wherein a time period encompassed during the deactivation of a cylinder and/or a rotational angle or revolution delay between a triggering and the deactivation of the cylinder is used as a time parameter for the time delay between the triggering and the reactivation of the deactivated cylinder.

4. The method as claimed in claim 1, wherein, in an engine speed adaptation process, a torque demand is predicted.

5. The method as claimed in claim 1, wherein a torque demand expected in future is taken as a basis for an injection control and/or reactivation of a deactivated cylinder.

6. The method as claimed in claim 1, wherein the individual cylinders are deactivated/reactivated by deactivation/reactivation of an injection.
